(19) United States
(12) Patent Application Publication
(10) Pub. No.: US 2012/0062513 A1
(43) Pub. Date: Mar. 15, 2012

(54) MULTI-FUNCTION TOUCH PANEL, MOBILE TERMINAL INCLUDING THE SAME, AND METHOD OF OPERATING THE MOBILE TERMINAL

(75) Inventors: Jin Goo KANG, Gunpo-si (KR); Dong Sub KIM, Suwon-si (KR); Hak Yeol KIM, Hwaseong-si (KR)

(73) Assignee: SAMSUNG ELECTRONICS CO. LTD., Suwon-si (KR)

(21) Appl. No.: 13/228,120

(22) Filed: Sep. 8, 2011

(30) Foreign Application Priority Data
Sep. 15, 2010 (KR) 10-2010-0090472

(51) Int. Cl. G06F 3/044; G06F 3/045

(52) U.S. Cl. 345/174

(57) ABSTRACT

A multi-function touch panel, a mobile terminal including the same, and a method of operating the mobile terminal are provided. The method includes performing, upon setting a mixed mode that alternately operates a touch panel in which a touch panel lower plate and a touch panel upper plate are disposed at a predefined gap with a resistive method and a capacitive method at a predefined cycle, proximity detection of an object approaching the touch panel and touch detection according to a predefined pressure applied to the touch panel according to a capacitive method at a predefined cycle, generating a distinguished input signal according to the proximity detection or the touch detection, and operating a specific user function according to the generated input signal.

### PRIORITY

This application claims the benefit under 35 U.S.C. § 119(a) of a Korean patent application filed on Sep. 15, 2010 in the Korean Intellectual Property Office and assigned Ser. No. 10-2010-0090472, the entire disclosure of which is hereby incorporated by reference.

### BACKGROUND OF THE INVENTION

1. Field of the Invention:

The present invention relates to a touch panel. More particularly, the present invention relates to a multi-function touch panel, a mobile terminal including the same, and a method of operating the mobile terminal that can operate various user functions based on a resistive touch panel.

2. Description of the Related Art:

Mobile terminals provide a communication function based on mobility and are used in wide fields due to their convenience and portability. In order to provide a user function, a mobile terminal provides various input methods. For example, as a mobile terminal of the related art provides a touch screen including a touch panel and a display unit, a user can perform an operation for selecting a specific image output to the display unit of the touch panel. The mobile terminal generates a touch event according to the user operation and controls an application program corresponding to a user function based on the touch event.

The touch panel may be classified into, for example, a resistive touch panel and a capacitive touch panel according to a touch event detection method. The resistive touch panel has a lower production cost than the capacitive touch panel. However, the resistive touch panel is lower in sensitivity than the capacitive touch panel. In the resistive touch panel, when an upper plate is disposed opposite to a lower plate at a predefined gap, a user applies pressure to a specific point of the upper plate and the lower plate and thus, when the upper plate and the lower plate contact, by detecting a change in resistance of a corresponding position, a touch point can be detected. In this case, a transparent PolyEthylene Terephthalate (PET) film coated with Indium Tin Oxide (ITO) may be used in the upper plate and the lower plate, and in order to detect a change in resistance value, a configuration of supplying a predefined power to the film coated with ITO is necessary. As described above, such a resistive touch panel of the related art only provides a touch detection function according to a change in resistance value due to a contact of an upper plate and a lower plate. Therefore, a limitation exists in operating various functions based on the resistive touch panel.

Therefore, a need exists for a multi-function touch panel, a mobile terminal including the same, and a method of operating a mobile terminal that can operate various user functions by alternately operating a touch panel of the mobile terminal

### SUMMARY OF THE INVENTION

Aspects of the present invention are to address at least the above-mentioned problems and/or disadvantages and to provide at least the advantages described below. Accordingly, an aspect of the present invention is to provide a multi-function touch panel, a mobile terminal including the same, and a method of operating the mobile terminal that can operate various user functions by alternately operating a touch panel of the mobile terminal in which an upper plate is disposed opposite to a lower plate with a resistive method and a capacitive method, performing proximity detection according to object access and touch detection according to a change in resistance value occurring in the touch panel and distinguishing and processing a detected signal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments the present invention will be more apparent from the following description taken in conjunction with the accompanying drawings, in which:

FIG. 1 is a block diagram illustrating a configuration of a mobile terminal according to an exemplary embodiment of the present invention;

FIG. 2 is a diagram illustrating a configuration of a touch panel of a mobile terminal according to an exemplary embodiment of the present invention;

FIG. 3 illustrates driving of a touch panel driving circuit according to an exemplary embodiment of the present invention;

FIG. 4 illustrates a display of a function operation of a mobile terminal upon operating a multi-function touch panel according to an exemplary embodiment of the present invention;

FIG. 5 illustrates a display of a function operation upon operating a multi-function touch panel according to an exemplary embodiment of the present invention; and

FIG. 6 is a flowchart illustrating a method of operating a mobile terminal including a multi-function touch panel according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a method of operating a mobile terminal that can operate various user functions by alternately operating a touch panel of the mobile terminal in which an upper plate is disposed opposite to a lower plate with a resistive method and a capacitive method, performing proximity detection according to object access and touch detection according to a change in resistance value occurring in the touch panel and distinguishing and processing a detected signal.

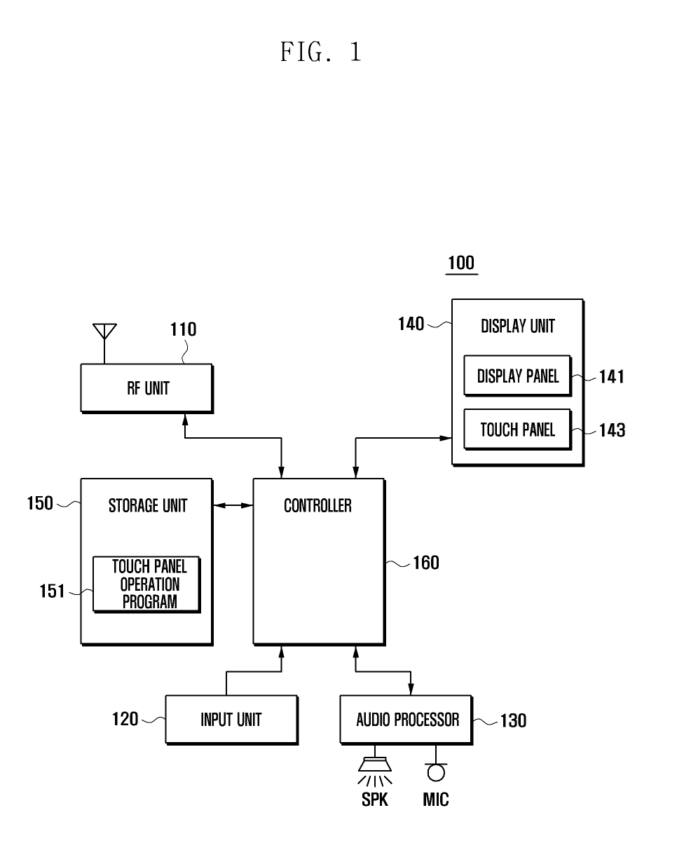

FIGS. 1 through 6, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 1 is a block diagram illustrating a configuration of a mobile terminal according to an exemplary embodiment of the present invention.

Referring to FIG. 1, a mobile terminal 100 includes a Radio Frequency (RF) unit 110, an input unit 120, an audio processor 130, a display unit 140, a storage unit 150, and a controller 160.

The mobile terminal 100 can provide various signals that can be detected in a touch panel 143 by alternately operating the touch panel 143 in which a touch panel upper plate is disposed opposite to a touch panel lower plate with a resistive method and a capacitive method according to a predefined cycle. That is, during a cycle in which the touch panel 143 operates with a capacitive method, the touch panel 143 detects a proximity degree of an object approaching the touch panel 143 and generates an input signal according to the detected proximity degree. Furthermore, during a cycle in which the touch panel 143 operates with a resistive method, the touch panel 143 detects a change in resistance value of a contact point between a touch panel upper plate (hereinafter, an upper plate) and a touch panel lower plate (hereinafter, a lower plate) by pressure applied to the touch panel 143. The touch panel 143 detects a touch point on the panel based on the detected change in resistance value and generates a corresponding input signal. Hereinafter, elements of the mobile terminal 100 are described below.

The RF unit 110 forms a communication channel for audio dedicated communication, a communication channel for audiovisual communication, and a communication channel for transmitting data, such as an image and a message by the control of the controller 160. That is, the RF unit 110 forms an audio dedicated communication channel, data communication channel, and an audiovisual communication channel between mobile communication systems. For this, the RF unit 110 includes an RF transmitter for up-converting a frequency of a signal to be transmitted and amplifying the signal, and an RF receiver for down-converting a frequency of a received signal and low-noise amplifying the signal. When the mobile terminal 100 has a communication function or a mobile communication function, the RF unit 110 is included in the mobile terminal 100, and when the mobile terminal 100 does not have a corresponding communication function, the RF unit 110 may be omitted. When a user uses a communication function, the RF unit 110 performs a function of transmitting and receiving a signal. When the RF unit 110 performs a function of transmitting and receiving a signal according to a communication function, the mobile terminal 100 controls release or setting of a touch lock state of the touch panel 143 based on a sensor signal according to a proximity degree of an object detected in the touch panel 143. A description of the RF unit 110 is provided below with reference to an example of a screen.

The input unit 120 includes a plurality of input keys and function keys for inputting numeral or character information and setting various functions. The function keys may include a navigation key, a side key, and a hotkey that are set to perform a specific function. Furthermore, the input unit 120 generates a key signal related to a user setting and function control of the mobile terminal 100 and outputs the key signal to the controller 160. The input unit 120 may be any one of a QWERTY keypad, a 3*4 keypad, and a 4*3 keypad including a plurality of keys. Furthermore, the input unit 120 may be any one of a QWERTY key map, a 3*4 key map, a 4*3 key map, and a control key map displayed on the display unit 140. When the display unit 140 of the mobile terminal 100 is formed in a full touch screen, the input unit 120 may include only a side key formed at a side surface of a case of the mobile terminal 100. More particularly, the input unit 120 is used for inputting an input signal for setting an operation mode of the touch panel 143. That is, the input unit 120 generates an input signal for setting the touch panel 143 to operate with only a resistive method and an input signal for setting the touch panel 143 to alternately operate with a resistive method and a capacitive method by the control of a user.

When an input signal for a resistive method exclusive setting or an input signal for setting a mixed mode of a resistance method and a capacitive method is generated, the input unit 120 outputs the generated input signal to the controller 160.

The audio processor 130 includes a speaker (SPK) for reproducing audio data to be transmitted/received when performing communication, audio data included in a received message, and audio data according to reproduction of an audio file stored at the storage unit 150, and a microphone (MIC) for collecting a user voice when performing communication, and the like. When a touch action occurs on the touch panel 143 of the mobile terminal 100, and thus a specific touch event occurs, the audio processor 130 outputs a sound effect according to a corresponding touch event. For example, the audio processor 130 may output different sound effects according to setting a resistive method exclusive mode of the touch panel 143 and setting a mixed mode of a resistive method and a capacitive method. An output of a sound effect according to setting of the touch panel 143 may be removed according to a user setting.

The display unit 140 includes a display panel 141 and the touch panel 143. The display unit 140 has a structure in which the touch panel 143 is disposed at a front surface of the display panel 141. A size of the display unit 140 is determined according to a size of the touch panel 143.

The display panel 141 displays information in which a user inputs information provided to a user as well as various menus of the mobile terminal 100. That is, the display panel 141 provides various screens according to use of the mobile terminal 100, for example, a standby screen, a menu screen, a message writing screen, and a communication screen. The display panel 141 may be formed with one of a Liquid Crystal Display (LCD) and an Organic Light Emitting Diode (OLED). More particularly, a screen output to the display panel 141 may be synchronized with setting of an effective touch area of the touch panel 143. The screen output to the display panel 141 may be changed according to a touch event or a proximity detecting signal occurring in the touch panel 143. A change of a screen output to the display panel 141 is described below with reference to the drawings.

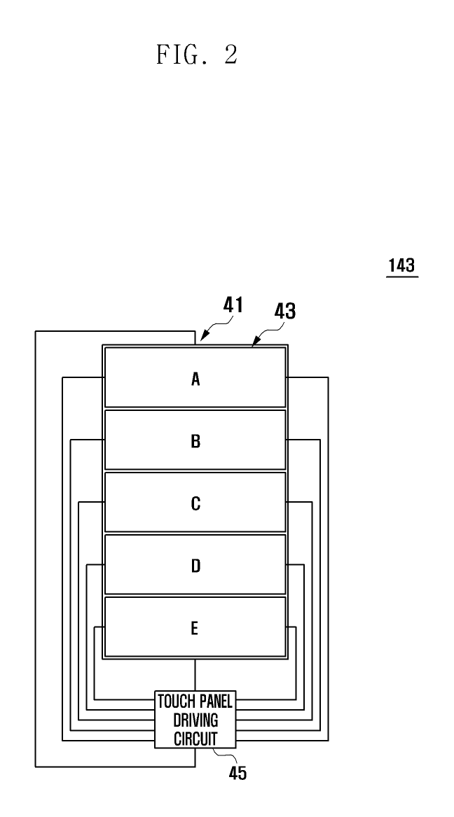

The touch panel 143 is disposed at an upper part of the display panel 141, generates a touch detection signal or a proximity detection signal according to a contact or an access distance of an object, and outputs the generated touch detection signal or proximity detection signal to the controller 160. In this case, at least one of an upper plate and a lower plate constituting the touch panel 143 is arranged in a stripe form or a matrix form. For example, the lower plate constituting the touch panel 143 may be formed in a single layer of a film coated with Indium Tin Oxide (ITO), and the upper plate is disposed opposite to the lower plate with a film material coated with ITO and in the upper plate, lines having a predefined length and width are arranged in parallel. Furthermore, an upper plate disposed on a lower plate of a single layer constituting the touch panel 143 is disposed in a lattice form at areas of a predefined form to cover an entire surface of the lower plate. When power is supplied, the touch panel 143 detects a change in resistance value of a point in which the lower plate and the upper plate contact and outputs the change in resistance value to the controller 160, thereby enabling the controller 160 to detect a touch point. Furthermore, the touch panel 143 generates a proximity detection signal according to a proximity degree change in which capacitance formed between the upper plate and the lower plate changes by an object approaching the panel and outputs the proximity detection signal to the controller 160. A structure of the upper plate and the lower plate may be formed in an opposite form. An exemplary structure of the touch panel 143 is described below with reference to FIG. 2.

The storage unit 150 stores a key map, a menu map, and information of a release area of a touch lock portion for operating the display unit 140 as well as an application program necessary for a function operation. Here, the key map and the menu map may be formed in various forms. That is, the key map may be a keyboard map, a 3*4 key map, or a QWERTY key map and may be a control key map for operation control of a presently activated application program. Furthermore, the menu map may be a menu map for operation control of a presently activated application program. The storage unit 150 may include a program area and a data area.

The program area stores an Operating System (OS) for booting and operation of the above elements of the mobile terminal 100, an application program for reproducing various files, for example, an application program for a communication function of the mobile terminal 100, a web browser for connecting to an Internet server, a Motion Pictures Expert Group (MPEG) Audio Layer-3 (MP3) application program for reproducing other sound sources, an image output application program for reproducing a picture, and a moving picture reproduction application program. More particularly, the program area may store a touch panel operation program 151.

At a point in time in which the touch panel 143 is activated according to schedule information, the touch panel operation program 151 is loaded to the controller 160 and supports operation of the touch panel 143. The touch panel operation program 151 includes a routine that controls power supply of the touch panel 143, a synchronization routine that synchronizes an area of the touch panel 143 with a screen of the display panel 141, a routine that determines a setting mode of the touch panel 143, a conversion routine that converts a setting mode of the touch panel 143 according to an input signal, a detecting control routine that controls a detecting operation of the touch panel 143 according to a set mode, and a function control routine that controls a user function according to a detected signal.

Here, the synchronization routine supports area synchronization with a screen output to the display panel 141 according to a shape of an upper plate and a lower plate of the touch panel. That is, when the upper plate is formed in a stripe form, the synchronization routine supports area synchronization of the touch panel 143, and when the upper plate is formed in a lattice form, the synchronization routine supports area synchronization of the touch panel 143. The conversion routine includes a subroutine that supports a resistive method exclusive setting mode and a subroutine that supports a mixed setting mode of a resistive method and a capacitive method. In a resistive method exclusive setting mode, the detection control routine includes a subroutine for determining a contact point of an upper plate and a lower plate by pressure applied to the touch panel 143 with a change in resistance value and for detecting a touch event based on a corresponding change in resistance value. Furthermore, in a mixed mode, the detection control routine includes a subroutine for detecting a change in capacitance by an object approaching the touch panel 143 and a touch event detection subroutine for detecting a change in resistance value according to a contact of the touch panel 143. The function control routine includes a subroutine for performing a user function according to a proximity detection signal and a subroutine for performing a user function according to occurrence of a touch event.

The data area stores data generated according to use of the mobile terminal 100 and stores phonebook data and at least one icon and various contents according to a widget function. Furthermore, the data area stores signals corresponding to a user input that is input through the touch panel 143. For example, while the touch panel 143 operates with an exclusive resistive method, the data area temporarily stores a touch event according to a change in resistance value, and while the touch panel 143 operates with a mixed mode of a resistive method and a capacitive method, the data area temporarily stores a proximity detection signal according to a change in capacitance. Furthermore, the data area stores a table of a user function to be performed according to a sensor signal output from the touch panel 143. When a specific application program is activated, the table stores information about functions to be performed according to a sensor signal output from the touch panel 143. Such a table may be provided on an application program basis.

The controller 160 controls power supplied to elements of the mobile terminal 100 and performs an initialization process. The controller 160 collects a sensor detection signal according to a setting mode of the touch panel 143 of the mobile terminal 100 and performs a user function according to collection of a sensor detection signal. More specifically, when the mobile terminal 100 is activated, the controller 160 determines a setting mode of the touch panel 143. When a setting mode of the touch panel 143 is a resistive method exclusive mode, the controller 160 detects a touch event according to a resistive method. When a setting mode of the touch panel 143 is a mixed method of a resistive method and a capacitive method, the controller 160 performs detection of a touch event according to a resistive method and proximity detection of a capacitive method according to a predefined cycle. Here, the controller 160 outputs a menu that can select a resistive method exclusive mode and a mixed mode of a resistive method and a capacitive method to the display unit 140, or selects a mode by allocating the menu to a specific key. The controller 160 performs a specific function of a presently activated application program according to a detection signal output from the touch panel 143. A function control of the controller 160 is described below with reference to the drawings to be described later.

As described above, the mobile terminal 100 alternately operates the touch panel 143 formed with an upper plate and a lower plate with a resistive method and a capacitive method according to a predefined cycle and thus, generates input signals of various forms. Here, the mobile terminal 100 may selectively operate a resistive method and a capacitive method according to user convenience by assigning an alternate operation of a resistive method and a capacitive method to a specific mode.

FIG. 2 is a diagram illustrating a configuration of a touch panel of a mobile terminal according to an exemplary embodiment of the present invention.

Referring to FIG. 2, a touch panel 143 includes a lower plate 41, an upper plate 43, a touch panel driving circuit 45, and signal lines.

The lower plate 41 is a layer having a single region of a predefined size and may be formed with a PolyEthylene Terephthalate (PET) film coated with ITO. A size of the lower plate 41 substantially corresponds to a size of the display unit 140 of the mobile terminal 100 or may be larger than a size of the display unit 140. The lower plate 41 may have a voltage difference from the upper plate 43 by power supplied by the touch panel driving circuit 45. Here, a magnitude of power supplied to the entire lower plate 41 is constantly maintained.

The upper plate 43 is disposed opposite to the lower plate 41 and may be divided into a predefined size. For example, in the upper plate 43, areas A, B, C, D, and E having a predefined size are constantly arranged on the lower plate 41 to be disposed in a stripe form. Here, an arrangement form of the areas A, B, C, D, and E of the upper plate 43 is not limited to a stripe form. That is, in the upper plate 43, predefined areas may be arranged in a lattice form on the lower plate 41. For this, in the upper plate 43, instead of a line form shown in FIG. 2, areas of a square form or a rectangular form in which the width and the length have a predefined ratio are disposed in a lattice form. Similarly to the lower plate 41, areas of the upper plate 43 may also be formed with a PET film coated with ITO.

Signal lines for detecting power supply to the areas A, B, C, D, and E of the upper plate 43 and the lower plate 41 and a change in resistance value or capacitance formed between the lower plate 41 and the upper plate 43 are provided between the lower plate 41 and the upper plate 43 and the touch panel driving circuit 45. The signal lines are each connected to both end portions of the lower plate 41 and both ends portions of the areas A, B, C, D, and E of the upper plate 43.

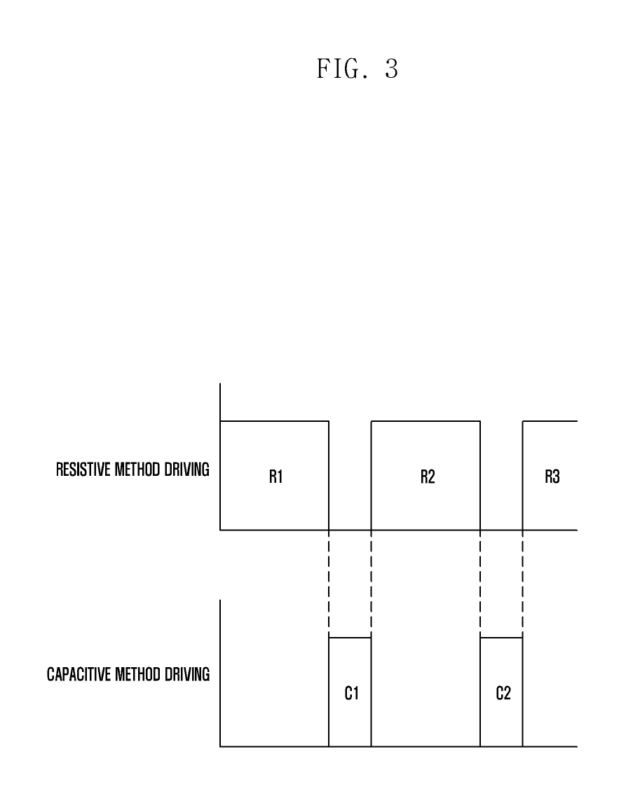

The touch panel driving circuit 45 supplies predefined power to the lower plate 41 and the upper plate 43 through the signal lines. The touch panel driving circuit 45 alternately detects a change in resistance value and a change in capacitance between the lower plate 41 and the upper plate 43 with a cycle of a predefined time period. An exemplary driving operation of the touch panel driving circuit 45 for driving the touch panel 143 is described below with reference to FIG. 3.

FIG. 3 illustrates driving of a touch panel driving circuit according to an exemplary embodiment of the present invention.

Referring to FIG. 3, a touch panel driving circuit 45 detects a change in resistance value occurring in the touch panel 143 for a cycle “R1” and detects a change in capacitance occurring in the touch panel 143 for the cycle “C1” after the cycle “R1” is complete. The touch panel driving circuit 45 performs the same operation as that of the cycle C1 for a cycle “C2” and performs the same operation as that of the cycle R1 for the cycle “R2” and “R3”. In this way, the touch panel driving circuit 45 controls to alternately perform touch detection of a resistive method and proximity detection of a capacitive method in a unit of a predefined cycle. Here, because the touch panel driving circuit 45 continues to supply predefined power to the lower plate 41 and the upper plate 43, the touch panel driving circuit 45 performs touch detection according to a change in resistance value by a contact between the lower plate 41 and the upper plate 43. Because the lower plate 41 is disposed opposite to the upper plate 43 at a predefined gap, by supplied predefined power and a gap formed between the lower plate 41 and the upper plate 43, electric charges are accumulated between the lower plate 41 and the upper plate 43. In other words, the lower plate 41 and the upper plate 43 perform a function of a capacitor. More particularly, in the touch panel 143, because areas A, B, C, D, and E of the lower plate 41 and the upper plate 43 perform a function of a capacitor, each of the areas A, B, C, D, and E of the upper plate 43 stores capacitance. When an object approaches a predefined area of the upper plate 43, electric charges accumulated in the upper plate 43 may change according to object access. In other words, specific areas A, B, C, D, and E of the upper plate 43 disposed opposite to the lower plate 41 perform proximity detection through a change in capacitance based on each area according to access of an object. The touch panel driving circuit 45 outputs collected detection signals to the controller 160 through the above-described touch detection and proximity detection.

In the foregoing description, a cycle of a resistive method and a cycle of a capacitive method can be adjusted according to a size of the touch panel 143, a kind of a presently activated application program, and a presently activated user function. That is, when a presently activated application program is an application program in which a request for proximity detection is small and in which a request for touch detection is large, for example, when a presently activated application program is an application program for an input of a character or writing of a message, a cycle of the resistive method may be relatively greater than that of the capacitive method. Furthermore, when a presently activated application program is an application program in which a request for touch detection is small and in which a request for proximity detection is large, for example, when a presently activated application program is an application program in which a voice communication function is activated, a cycle of the capacitive method may be relatively greater than that of the resistive method. Here, increase and decrease of a cycle may have an influence on at least one of a length and the number of times of a cycle.

As described above, touch panel driving according to an exemplary embodiment of the present invention can support operation of the touch panel 143 optimized for a corresponding function by adjusting an operation cycle of a resistive method and an operation cycle of a capacitive method according to a kind of a presently activated application program and a user function. Hereinafter, an exemplary user function to which the touch panel driving is applied is described below with reference to a screen example.

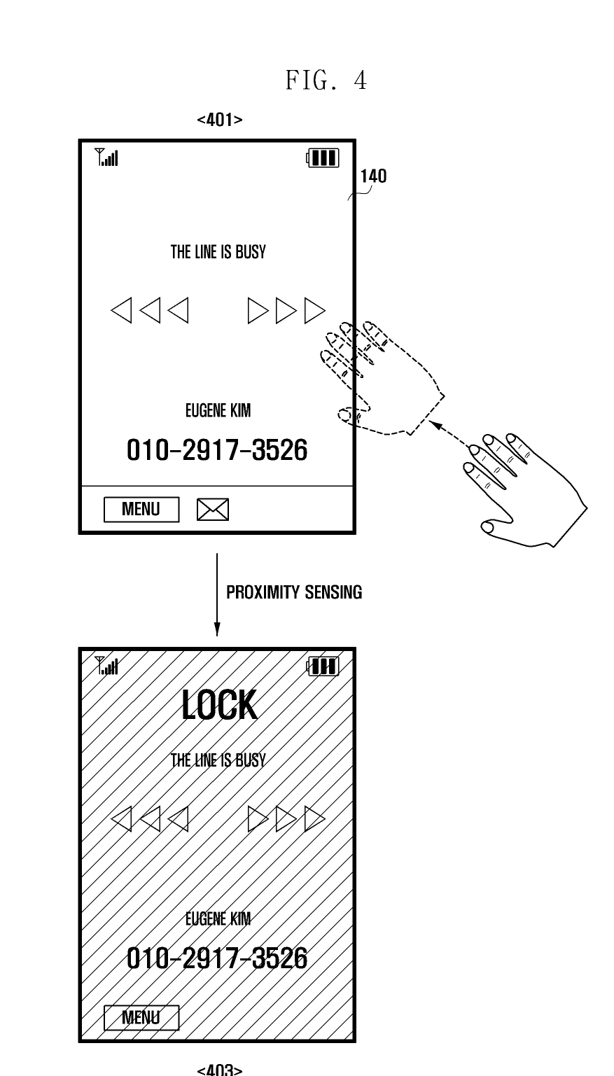

FIG. 4 illustrates a display of a function operation of a mobile terminal upon operating a multi-function touch panel according to an exemplary embodiment of the present invention.

Referring to FIG. 4, a mobile terminal 100 may represent that a phone of another party is busy. Therefore, when a user of the mobile terminal 100 requests communication to another mobile terminal or receives a communication request from another mobile terminal, the user can perform a response call thereto. Thereby, the mobile terminal 100 forms a communication channel with another mobile terminal having a phone number in which communication is requested. In this case, the controller 160 controls the display unit 140 to display a screen representing a busy state, as in a screen 401. Here, in a state where a standby screen is first output, the mobile terminal 100 operates the touch panel 143 in a resistive method exclusive mode according to user setting. When a specific application program is activated, as in the screen 401, the mobile terminal 100 automatically converts a resistive method exclusive mode to a mixed mode of a resistive method and a capacitive method according to activation of a corresponding application program. Alternatively, the user of the mobile terminal 100 may input an input signal for conversion to the mixed mode, and as an input signal for conversion to the mixed mode is input, a mode of the touch panel 143 may be converted in a setting mode of the touch panel 143. Accordingly, while the mobile terminal 100 performs a communication function, the mobile terminal 100 alternately performs touch detection of a resistive method and proximity detection of a capacitive method according to a predefined cycle.

While representing that another party's phone is in a busy state, when an object, for example a hand approaches, the mobile terminal 100 performs proximity detection of the hand. For this, the touch panel driving circuit 45 alternately performs touch detection and proximity detection according to a predefined cycle and detects a change in capacitance by an object approaching the touch panel 143. When the change in capacitance is more than a preset value, the touch panel driving circuit 45 outputs a proximity sensor signal according to object access to the controller 160 of the mobile terminal 100.

When the touch panel driving circuit 45 generates a proximity sensor signal and outputs the proximity sensor signal to the controller 160 of the mobile terminal 100, the controller 160 converts a state of the touch panel 143 to a touch lock state i.e., to convert a specific user function of the mobile terminal 100, for example as in a screen 403. Here, access of the object is illustrated as access of a hand. However, when a user holds the mobile terminal 100 and moves the mobile terminal 100 to an area adjacent to an ear and cheek area for communication, the mobile terminal 100 performs proximity detection to the ear and cheek area adjacent to the touch panel 143. Accordingly, the mobile terminal 100 automatically changes a state of the touch panel 143 to a touch lock state.

When a change in capacitance is reduced to a predefined value or less or capacitance is returned to previous capacitance by the proximity detection, in other words, when an adjacent object recedes from the touch panel 143, the touch panel driving circuit 45 of the mobile terminal 100 generates a proximity sensor signal corresponding thereto and outputs the proximity sensor signal to the controller 160. Accordingly, the controller 160 automatically releases a touch lock state that is set at the touch panel 143. Furthermore, the controller 160 may convert the mixed mode to a resistive method exclusive mode together with release of a touch lock state. Here, conversion to a setting mode of the touch panel 143 may not be performed by a user's setting or a designer's setting.

As described above, the mobile terminal 100 may automatically convert a setting mode of the touch panel 143 according to activation of an application program or manually convert according to a user request and activate various user functions according to proximity detection occurring in a process of performing a specific user function. Therefore, the mobile terminal 100 can easily set a more convenient function without a separate additional element.

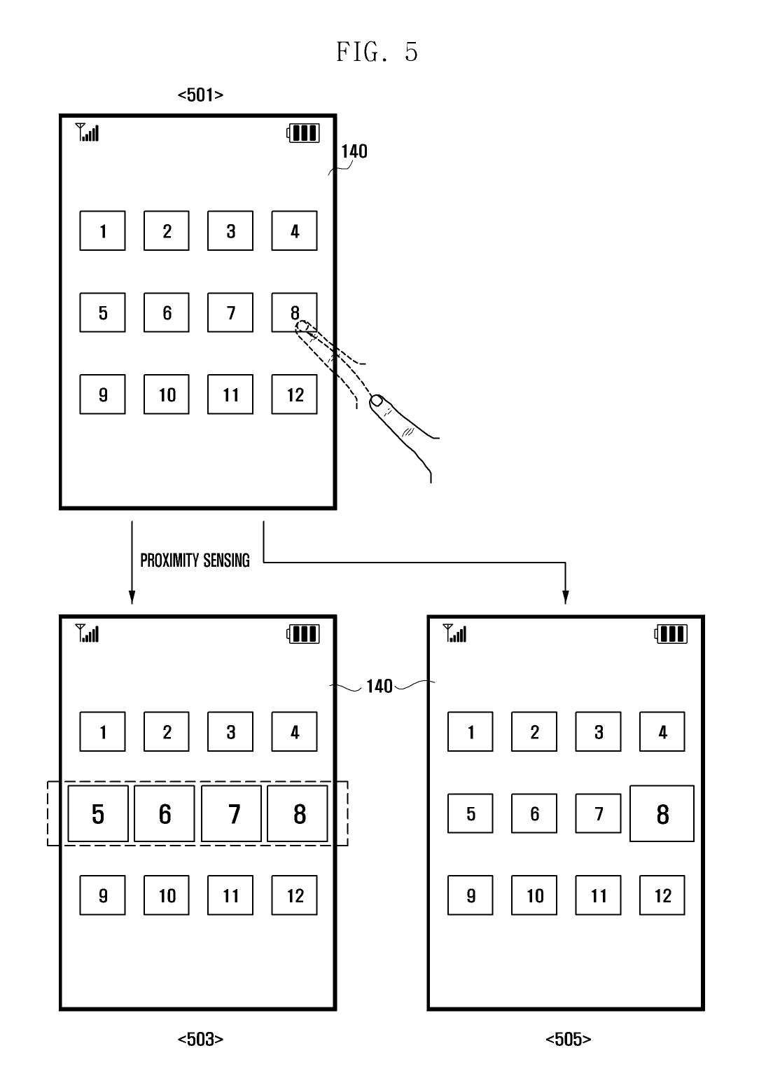

FIG. 5 illustrates a display of a function operation of a mobile terminal upon operating a multi-function touch panel according to an exemplary embodiment of the present invention.

It is assumed that the touch panel 143 of a mobile terminal 100 is set to a mixed mode of a resistive method and a capacitive method.

Referring to FIG. 5, the mobile terminal 100 outputs a menu screen to the display unit 140, as in a screen 501. The menu screen output to the display unit 140 may include various menu items 1, 2, 3, 4, 5, 6, 7, 8, 9, 10, 11, and 12. Here, the menu items 1, 2, 3, 4, 5, 6, 7, 8, 9, 10, 11, and 12 have a form in which Arabic numerals are written in a quadrangular form. However, exemplary embodiments of the present invention are not limited thereto. That is, the menu items 1, 2, 3, 4, 5, 6, 7, 8, 9, 10, 11, and 12 may have a form of a closed curved line including a straight line and a curved line, such as a triangle, a pentagon, or a circle, and may be expressed in various forms by a free curved line. Texts or colors written within the menu items 1, 2, 3, 4, 5, 6, 7, 8, 9, 10, 11, and 12 may also be variously expressed. The display unit 140 displays an output of 12 menu items 1, 2, 3, 4, 5, 6, 7, 8, 9, 10, 11, and 12. However, the display unit 140 may have the changed number according to a form that is set to the mobile terminal 100. It is described that the mobile terminal 100 outputs menu items 1, 2, 3, 4, 5, 6, 7, 8, 9, 10, 11, and 12 to the display unit 140. However, the mobile terminal 100 may output widget icons, other texts, images, and the like. The mobile terminal 100 can operate the touch panel 143 in a mixed mode.

In a state where the display unit 140 of the mobile terminal 100 outputs menu items 1, 2, 3, 4, 5, 6, 7, 8, 9, 10, 11, and 12, when a user's finger or another object approaches the touch panel 143 of the display unit 140 by a predefined distance or more, the touch panel 143 detects a change in capacitance with proximity of the finger according to operation of the mixed mode. Accordingly, the mobile terminal 100 can change a menu screen output with one method of screens 503 and 505 according to a structure of the touch panel 143.

More specifically, as described in FIG. 2, in a structure of the upper plate 43 and the lower plate 41 of the touch panel 143, when an upper plate areas A, B, C, D, and E having several predefined lengths and widths are disposed in a stripe form on the lower plate 41 having a predefined area, the mobile terminal 100 changes a screen, as in the screen 503 according to proximity detection at a screen 501. That is, the mobile terminal 100 differently expresses an image of the display panel 141 disposed at a specific touch panel area in which proximity detection is performed from an image of other areas. For example, the mobile terminal 100 enlarges and outputs an image of the display panel 141 corresponding to a specific touch panel area in which proximity detection is performed in a predefined ratio. Here, because the touch panel 143 is arranged in stripe form areas having a predefined length and width, when proximity detection occurs on a specific stripe form area, the mobile terminal 100 changes an entire image of a corresponding touch panel area. A user of the mobile terminal 100 can move a finger on the touch panel 143 and thus the mobile terminal 100 partially enlarges and outputs an image of the display panel 141 according to proximity detection by access of a finger. Accordingly, the user can easily select an enlarged image, i.e., a specific item on the display panel 141. In this process, the mobile terminal 100 adjusts setting of an effective area of the touch panel 143 corresponding to an area in which an image is enlarged together with enlargement of an image of the display panel 141. For example, the touch panel 143 of an area in which the image is enlarged may enlarge a touch effective area by enlarged images.

When areas of the upper plate 43 disposed on the lower plate 41 of the touch panel 143 have a predefined length and width and are disposed in a lattice form, the mobile terminal 100 changes an image, as in the screen 505 according to proximity detection. That is, when an object approaches the display panel 141 to which an item 8 of menu items is output, the mobile terminal 100 performs proximity detection to access of an object for a cycle in which the touch panel 143 is operated with a capacitive method and recognizes that an object approaches an area to which the item 8 is output. Substantially, because a resistive method and a capacitive method are alternately operated according to a predefined cycle, the touch panel 143 determines a proximity degree of an approaching object with a predefined cycle. Therefore, the mobile terminal 100 can apply a specific user function, for example an enlargement function to a corresponding area according to a proximity degree of an object determined with a predefined cycle. In other words, the mobile terminal 100 can enlarge and output an image of the display panel 141 to which the item 8 is output and set a touch effective area of a corresponding touch panel 143 to correspond to an enlarged image.

In the foregoing description, only enlargement of an image of a specific area according to proximity detection is described. However, the mobile terminal 100 can additionally change a screen according to enlargement of an image i.e., move a position of other images. For example, when the item 8 is enlarged in a predefined ratio at a corresponding position, the mobile terminal 100 moves and displays positions of each menu item in a predefined direction based on the item 8.

In the foregoing description, an output of menu items, and enlargement of a partial image and setting of an effective area of a touch panel according to a characteristic of the touch panel 143 are described. However, exemplary embodiments of the present invention are not limited thereto. That is, the mobile terminal 100 may output a text screen having setting of an output screen dash link of menu items. Accordingly, a user may enlarge a specific image of the display panel 141 by approaching an object to a specific area of a text screen. In this process, a text area having link setting may be enlarged, and thus the user can easily view linked information by selecting more easily an enlarged link.

As described above, the mobile terminal 100 having a multi-function touch panel alternately operates the touch panel 143 with a resistive method and a capacitive method at a predefined cycle and thus performs proximity detection based on a change in capacitance according to object access and touch detection for detecting a change in resistance value of a touch panel and distinguishes and generates input signals thereof As a result, the mobile terminal 100 can operate various user functions based on generation of the distinguished input signals. Furthermore, when the mobile terminal 100 is operated in a mixed mode, the mobile terminal 100 activates a specific application program according to proximity detection and generates an input signal for operation of an activated application program according to touch detection occurring immediately after proximity detection and thus a user can more quickly and easily operate a specific application program.

Hereinafter, an exemplary method of operating a mobile terminal including the touch panel 143 is described below with reference to a flowchart.

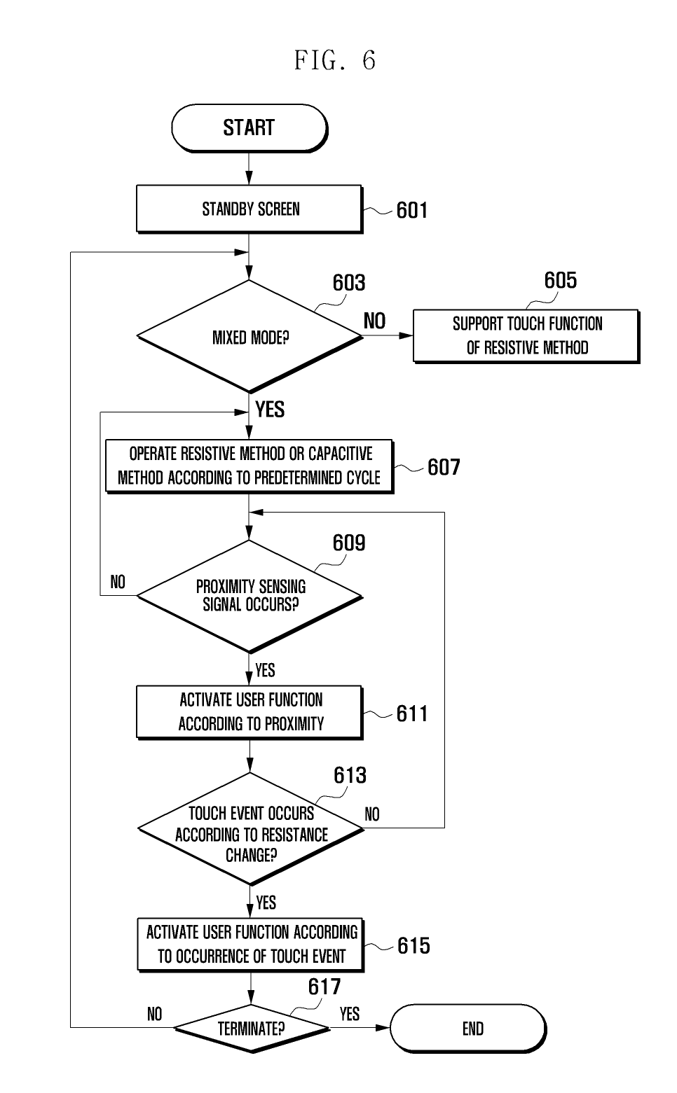

FIG. 6 is a flowchart illustrating a method of operating a mobile terminal including a multi-function touch panel according to an exemplary embodiment of the present invention.

Referring to FIG. 6, in an exemplary method of operating a mobile terminal, when power is supplied to the mobile terminal 100, the controller 160 initializes elements of the mobile terminal 100 using supplied power and outputs a standby screen according to preset schedule information at step 601.

The controller 160 determines whether a mixed mode of a resistive method and a capacitive method is set at step 603. That is, the controller 160 determines whether an input signal for setting a mixed mode for alternately operating the touch panel 143 with a resistive method and a capacitive method is generated or schedule information for automatic setting exists. Here, the mixed mode setting may exist as a function linked to activation of a specific application program. That is, when a specific application program of the mobile terminal 100 is activated, the mixed mode setting may be set to automatically convert an operation mode of the touch panel 143. Accordingly, the controller 160 automatically converts presently set mode setting of the touch panel 143 according to whether a specific application program is activated or whether a specific application program is terminated.

If it is determined at step 603 that a mixed mode of a resistive method and a capacitive method is not set i.e., if an input signal, schedule information, or a specific event for setting a mixed mode does not exist, the controller 160 supports a touch function according to a change in resistance value by operating the touch panel 143 in a resistive method exclusive mode at step 605.

In contrast, if it is determined at step 603 that a mixed mode of a resistive method and a capacitive method is set i.e., if an input signal, schedule information, or a specific event for setting a mixed mode exists, the controller 160 converts and operates the touch panel 143 to a resistive method or a capacitive method according to a predefined cycle in a mixed mode at step 607.

When the touch panel 143 is alternately operated with a resistive method and a capacitive method, proximity detection according to object access occurs earlier than touch recognition according to a change in resistance value and thus the controller 160 determines whether a proximity detection signal occurs at step 609.

If it is determined at step 609 that a proximity detection signal does not occur, the process returns to step 607.

In contrast, if it is determined at step 609 that a proximity detection signal occurs, the controller 160 activates a user function according to occurrence of a proximity detection signal at step 611. Here, execution of a user function includes execution of an activation function of a specific application program, execution of a specific function of a presently activated application program, and execution of a function of invalidating a generated proximity detection signal according to a presently activated application program.

The controller 160 determines whether a touch event occurs according to a resistance change at step 613. That is, the controller 160 determines whether object access according to proximity detection is connected to a contact to the touch panel 143 for a resistance change. In this process, if it is determined at step 613 that a resistance change does not exist, the process returns to step 609.

In contrast, if it is determined at step 613 that a touch event occurs according to a resistance change, the controller 160 activates a user function according to occurrence of a touch event at step 615.

Activation of a user function according to occurrence of a touch event at step 615 may be different from activation of a user function at step 611. That is, generation of an input signal according to proximity detection at step 611 is different from generation of an input signal according to a touch event at step 615 and thus execution of a user function by corresponding input signals may be differently performed.

At step 617, the controller 160 determines whether the mobile terminal 100 is terminated.

If it is determined at step 617 that the mobile terminal 100 is not terminated, i.e., if an input signal or an event for termination does not occur, the process returns to step 603. In contrast, if it is determined at step 617 that the mobile terminal 100 is terminated, i.e., if an input signal or an event for termination occurs, the controller 160 may convert a presently set setting mode of the touch panel 143 while controlling to terminate a corresponding application program.

In the foregoing description, in several forms of a touch panel, a form in which an upper plate is physically divided into predefined areas and has a stripe form or a lattice form is exemplified. However, a mixed mode according to an exemplary embodiment of the present invention can be applied even to a form in which an upper plate is formed in a single area. Even in this case, a mobile terminal generates a distinguished input signal according to proximity detection and touch detection, thereby performing a specific user function, such as a touch lock function described with reference to FIG. 4 upon proximity detection.

As described above, a multi-function touch panel, a mobile terminal including the same, and a method of operating the mobile terminal can perform a mixed mode that can alternately operate a touch panel formed with an upper plate and a lower plate with a resistive method and a capacitive method, thereby supporting generation of various input signals and thus controlling execution of a user function.

The mobile terminal 100 may include a short range communication module for short range communication, a camera module for photographing a still image/moving picture of a subject, an interface for transmitting and receiving data according to a wired/wireless communication method of the mobile terminal 100, an Internet communication module for performing an Internet function by communicating with an Internet network, and a digital broadcasting module for performing a receiving and reproducing function of digital broadcasting.

Furthermore, the mobile terminal 100 may include devices including a touch panel. For example, the mobile terminal 100 may be mobile communication terminals operating by communication protocols corresponding to various communication systems and may be an information and communication device or a multimedia device, such as a Portable Multimedia Player (PMP), a digital broadcasting player, a Personal Digital Assistant (PDA), a music player (e.g., MP3 player), a portable game terminal, a smart phone, a laptop computer, a hand-held Personal Computer (PC), and applications thereof

In a multi-function touch panel, a mobile terminal including the same, and a method of operating the mobile terminal, by dividing and operating a touch panel formed with an upper plate and a lower plate into a resistive method and a capacitive method at a predefined time interval, various input signals can be detected and thus various user functions of the mobile terminal can be operated.

While the invention has been shown and described with reference to certain exemplary embodiments thereof, it will be understood by those skilled in the art that various changes in form and details may be made therein without departing from the spirit and scope of the invention as defined by the appended claims and equivalents.

What is claimed is:

1. A multi-function touch panel comprising:
a touch panel lower plate disposed opposite to a touch panel upper plate at a predefined gap; and
a touch panel driving circuit for detecting a signal according to proximity detection and touch detection by alternately operating with a resistive method and a capacitive method according to a predefined cycle based on the touch panel lower plate and the touch panel upper plate.

2. The multi-function touch panel of claim 1, wherein the touch panel upper plate comprises at least one of areas having a predefined length and width disposed in a stripe form on the touch panel lower plate and areas having a predefined length and width disposed in a lattice form on the touch panel lower plate.

3. The multi-function touch panel of claim 1, wherein the touch panel driving circuit supplies predefined power to the touch panel upper plate and the touch panel lower plate, and when operating with the resistive method, the touch panel driving circuit performs touch detection by detecting a change in resistance value by a contact of the touch panel upper plate and the touch panel lower plate, and when operating with a capacitive method, the touch panel driving circuit performs proximity detection with a change in capacitance formed between the touch panel upper plate and the touch panel lower plate.

4. A mobile terminal comprising:
a touch panel in which a touch panel lower plate and a touch panel upper plate are disposed at a predefined gap and comprising a touch panel driving circuit for detecting a signal according to proximity detection and touch detection by alternately operating with a resistive method and a capacitive method according to a predefined cycle based on the touch panel lower plate and the touch panel upper plate; and
a controller for generating a distinguished input signal according to a detection signal output from the touch panel and for activating a specific user function according to the generated input signal.

5. The mobile terminal of claim 4, wherein the touch panel upper plate comprises at least one of areas having a predefined length and width disposed in a stripe form on the touch panel lower plate and areas having a predefined length and width disposed in a lattice form on the touch panel lower plate.

6. The mobile terminal of claim 4, wherein the controller sets a mode of the touch panel to an exclusive mode of operating the touch panel with only a resistive method or to a mixed mode of a resistive method and a capacitive method according to activation or termination of an application program.

7. The mobile terminal of claim 4, further comprising an input unit for inputting an input signal for converting to a mixed mode and an exclusive mode.

8. The mobile terminal of claim 4, wherein the controller activates a specific application program when an input signal according to the proximity detection occurs and applies an input signal according to touch detection occurring after the proximity detection to the application program.

9. The mobile terminal of claim 4, wherein the controller converts a state of the touch panel to a touch lock state when a specific application program is activated and an input signal according to proximity detection occurs and releases the touch lock state of the touch panel when a proximity degree according to the proximity detection is less than or equal to a predefined value.

10. The mobile terminal of claim 4, wherein the controller changes and outputs an image on a display panel corresponding to an area in which proximity detection occurs when a specific application program is activated and an input signal according to proximity detection occurs.

11. The mobile terminal of claim 4, wherein the controller adjusts a length or the number of times of an operating cycle of the resistive method and an operating cycle of the capacitive method to be alternately operated according to a kind of an activated application program.

12. A method of operating a mobile terminal comprising a multi-function touch panel, the method comprising:
performing proximity detection of an object approaching a touch panel and touch detection according to a predefined pressure applied to the touch panel according to a capacitive method at a predefined cycle;
generating a distinguished input signal according to the proximity detection or the touch detection; and
operating a specific user function according to the generated input signal.

13. The method of claim 12, further comprising setting at least one of an exclusive mode of operating the touch panel with only a resistive method and a mixed mode.

14. The method of claim 13, wherein the setting of the at least one of the exclusive mode of operating the touch panel with only a resistive method and a mixed mode comprises at least one of:
converting the mixed mode and the exclusive mode according to generation of an input signal for setting the mode;
automatically converting a mode of the touch panel according to activation of a specific user function of the mobile terminal; and
automatically converting a mode according to whether the activated specific user function is terminated.

15. The method of claim 12, wherein the operating of the specific user function according to the generated input signal comprises:
activating, when an input signal according to the proximity detection occurs, a specific application program; and
applying an input signal according to touch detection occurring after the proximity detection to the application program.

16. The method of claim 12, wherein the operating of the specific user function according to the generated input signal comprises at least one of:
converting, when a specific application program is activated and an input signal according to proximity detection occurs, a state of the touch panel to a touch lock state; and
releasing, when a proximity degree according to the proximity detection is less than or equal to a predefined value, the touch lock state of the touch panel.

17. The method of claim 12, wherein the operating of the specific user function according to the generated input signal comprises changing, when a specific application program is activated and an input signal according to proximity detection occurs, an image of a display panel corresponding to an area in which proximity detection occurs.

18. The method of claim 12, further comprising adjusting a length or the number of times of an operating cycle of the resistive method and an operating cycle of the capacitive method to be alternately operated according to a kind of an activated application program.
